(19) United States
(12) Patent Application Publication
(10) Pub. No.: US 2015/0244737 A1
(43) Pub. Date: Aug. 27, 2015

(54) DETECTING MALICIOUS ADVERTISEMENTS USING SOURCE CODE ANALYSIS

(71) Applicant: CHECKMARX LTD., Tel Aviv (IL)

(72) Inventor: Maty Siman, Tel-Aviv (IL)

(21) Appl. No.: 14/428,408

(22) PCT Filed: Sep. 22, 2013
(86) PCT No.: PCT/IB2013/058741

§ 371 Date: Mar. 16, 2015

Related U.S. Application Data
(60) Provisional application No. 61/705,157, filed on Sep. 25, 2012.

(51) Int. Cl. H04L 29/06; G06F 9/45; G06Q 30/02

(52) U.S. Cl. CPC H04L 63/1466; G06Q 30/0248; G06F 8/53

(57) ABSTRACT

A method for software code analysis includes receiving in a computer (36), from a requester, an item of active content to be played on client devices. The computer automatically analyzes source code of the item in order to generate a data flow graph, representing a flow of information to be engendered in the client devices playing the item. It automatically processes the source code and the data flow graph in order to detect elements in the flow of the information that deviate from a predefined set of norms, and reports deviations from one or more of the norms to the requester.

### CROSS-REFERENCE TO RELATED APPLICATIONS

This application claims the benefit of U.S. Provisional Patent Application 61/705,157, filed Sep. 25, 2012, which is incorporated herein by reference.

### FIELD OF THE INVENTION

The present invention relates generally to computer software, and particularly to automatic detection of attempts to exploit vulnerabilities in computer software.

### BACKGROUND

Application-level software code is prone to security vulnerabilities. Such vulnerabilities may be introduced intentionally by programmers, who may then exploit the vulnerabilities that they have created in order to escalate their privileges and perform unauthorized actions in the computer system.

Network advertisements have been used as a vehicle for introducing malicious software of this sort into victim computers. Advertisements that are inserted into Web pages frequently make use of the Adobe Flash® Player that is installed as a browser plug-in on most network-enabled computers and mobile devices. Numerous security vulnerabilities have already been discovered in such Flash Players. As a precaution against exploitation of such vulnerabilities, a number of techniques have been applied in order to detect malicious advertisements, including behavior-based methods—running the ad in a closed environment (“Sandbox”) and observing its activity—and signature-based antivirus methods. To date these techniques have had only partial success.

Other methods for detection of software vulnerabilities use source code analysis. For example, U.S. Patent Application Publication 2010/0083240, whose disclosure is incorporated herein by reference, describes a tool that automatically analyzes source code for application-level vulnerabilities. Operation of the tool is based on static analysis, but it makes use of a variety of techniques, for example methods of dealing with obfuscated code.

### SUMMARY

Embodiments of the present invention that are described hereinbelow provide methods, apparatus and software for use in detecting vulnerabilities in active content, such as Flash-based advertisements.

There is therefore provided, in accordance with an embodiment of the present invention, a method for software code analysis, which includes receiving in a computer, from a requester, an item of active content to be played on client devices. Source code of the item is automatically analyzed, in the computer, in order to generate a data flow graph, representing a flow of information to be engendered in the client devices playing the item. The source code and the data flow graph are automatically processing in the computer in order to detect elements in the flow of the information that deviate from a predefined set of norms. Deviations from one or more of the norms are reported to the requester.

In some embodiments, the item of the active content is designed for insertion into a Web page for display by browsers of the client devices and may include a Flash advertisement. In one embodiment, the requester is an advertisement broker, who distributes items for insertion in multiple Web sites, and the method includes, upon finding no deviations from the norms due to a given item, certifying to the advertisement broker that the given item has been verified.

In a disclosed embodiment, the item includes receiving object code, and analyzing the source code includes decompiling the object code in order to generate the source code. Additionally or alternatively, analyzing the source code includes generating an object-based representation of the source code, and extracting the data flow graph from the object-based representation.

In some embodiments, processing the source code includes detecting components in the source code that are likely to cause a buffer overflow in the client devices. The components detected may include one or more information elements, selected from a group of the information elements consisting of a line of code containing more than a first predefined number of characters; a string or concatenation of strings containing more than a second predefined number of string characters without interruption; a first number of numerical elements having respective values greater than a first predefined threshold, such that the first number is greater than a first predefined quota; a second number of multiplication operators having at least one operand greater than a second predefined threshold, such that the second number is greater than a second predefined threshold; and a third number of instructions of a predefined type, such that the third number is greater than a third predefined threshold.

Additionally or alternatively, processing the source code includes detecting actions that the item of the active content is programmed to perform, such that the detected actions fall within a set of predefined actions associated with potential exploitation of the client devices. The predefined actions may be selected from a group of actions consisting of interaction with, modification of, or manipulation of a hosting page on which the item of the active content is to be displayed; opening the item of the active content to play in full-screen mode; timer-based actions, to be performed autonomously without intervention of users of the client devices; navigating away from a hosting site, on which the item of the active content is to be displayed, to another, different site; downloading further active content from another site, different from the hosting site, on which the item of the active content is to be displayed; downloading an executable program to client devices; building a string meeting predefined criteria; an alteration in a functionality of the item of the active content that is scheduled to occur after a predefined time has elapsed; an alteration in a functionality of the item of the active content that is scheduled to occur on a certain day; and scanning for open ports.

There is also provided, in accordance with an embodiment of the present invention, apparatus for software code analysis, including an interface, configured to receive, from a requester, an item of active content to be played on client devices. A processor is configured to analyze source code of the item in order to generate a data flow graph, representing a flow of information to be engendered in the client devices playing the item, to process the source code and the data flow graph in the computer in order to detect elements in the flow of the information that deviate from a predefined set of norms, and to report deviations from one or more of the norms to the requester.

There is additionally provided, in accordance with an embodiment of the present invention, a computer software product, including a non-transitory computer-readable medium in which program instructions are stored, which instructions, when read by a computer, cause the computer to receive, from a requester, an item of active content to be played on client devices, to analyze source code of the item in order to generate a data flow graph, representing a flow of information to be engendered in the client devices playing the item, to process the source code and the data flow graph in the computer in order to detect elements in the flow of the information that deviate from a predefined set of norms, and to report deviations from one or more of the norms to the requester.

The present invention will be more fully understood from the following detailed description of the embodiments thereof, taken together with the drawings in which:

### BRIEF DESCRIPTION OF THE DRAWINGS

FIG. 1 is block diagram that schematically illustrates a system for content verification and distribution, in accordance with an embodiment of the present invention;

FIG. 2 is a block diagram that schematically shows elements of an a content verification server, in accordance with an embodiment of the present invention; and

FIG. 3 is a flow chart that schematically illustrates a method for content verification, in accordance with an embodiment of the present invention.

### DETAILED DESCRIPTION OF EMBODIMENTS

As noted above, items of active content, such as Flash advertisements, are frequently used to deliver malicious content to client devices, such as personal computers and mobile computing and communication devices. The term “active content” is used in the present description and in the claims to refer to content that is not simply displayed on the client device, but rather includes multimedia components such as video, animations, and/or interactive graphics. Items of such active content are typically downloaded to client devices in the form of files (such as SWF files for Flash items, or HTML5 files, as another example), to be opened and played by a suitable program, such as a Web browser or plug-in, on the client device. Such files are commonly embedded in or linked to documents, such as Web pages, for download to the client devices.

Web site operators often sell space on their Web pages to advertisers, and then insert links in their Web pages to content provided by such advertisers. Such advertisements frequently contain active content, and may thus be used, without the knowledge of the Web site operator, to deliver malicious software that exploits vulnerabilities of the corresponding player program (such as the Flash player) on the client device. Malicious active content of this sort both exposes the client device to attack and exposes the Web site operator and advertisement broker to liability.

In order to avoid such exposure, Web site operators and advertisement brokers may apply the sorts of detection techniques that are described above in the Background section, such as “sandbox” and signature-based techniques, to items of active content before allowing these items to be distributed to client devices. Signature-based techniques, however, are effective only against known malicious content that was previously identified, while sandbox techniques cannot generally detect activity that is timed (by the malicious programmer of the content item), as is often the case, to occur only after an extended delay.

Embodiments of the present invention that are described hereinbelow address the need to detect malicious active content in a manner that overcomes the limitations of existing methods. The present embodiments make use of techniques of source code analysis that are described, for example, in the above-mentioned U.S. Patent Application Publication 2010/0083240, while extending and adapting these techniques to the particular sorts of problems that arise in handling items of active content.

The inventors have found that software attacks based on active content items, such as Flash files, commonly use one of two methods:
Exploiting standard, documented functionality of the environment of the client-side player (such as the Flash player); and
Exploiting vulnerabilities (such as buffer-overflows) in the players themselves.
   Each of these methods has specific characteristics that allow static code analysis tools to recognize, with a high degree of accuracy, whether the analyzed item of active content is malicious or not. For example, malicious content often limits its offensive activity to a specific time and/or date (over a weekend, for example, when people are out of the office) or to specific time zones. In some cases, the malicious active content item may redirect the client device to other pages (URLs) or scans open network ports. Authors of malicious active content items often try to circumvent the Same Origin Policy (SOP) that is implemented in Web browsers in order to take control of the screen (“Full Screen Mode”) and/or execute malicious JavaScripts. Items attempting to exploit buffer overflow usually contain or generate a large set of binary strings, which are the actual payload of the buffer overflow.

The above patterns may be difficult to identify using existing techniques, but can be detected readily using the source code analysis techniques that are described herein. In the disclosed embodiments, a computer receives from a requester an item of active content that is to be played on client devices. In an example scenario described below, the computer is a verification server, which receives advertisements for verification from advertisement brokers and Web site operators, but the disclosed techniques may be implemented on substantially any suitable computer. The computer automatically analyzes source code of the item in order to generate a data flow graph. Such a graph represents the flow of information to be engendered in client devices playing the item in question. The computer automatically processes the source code and the data flow graph in order to detect elements in the flow of the information that deviate from a predefined set of norms, and reports such deviations to the requester.

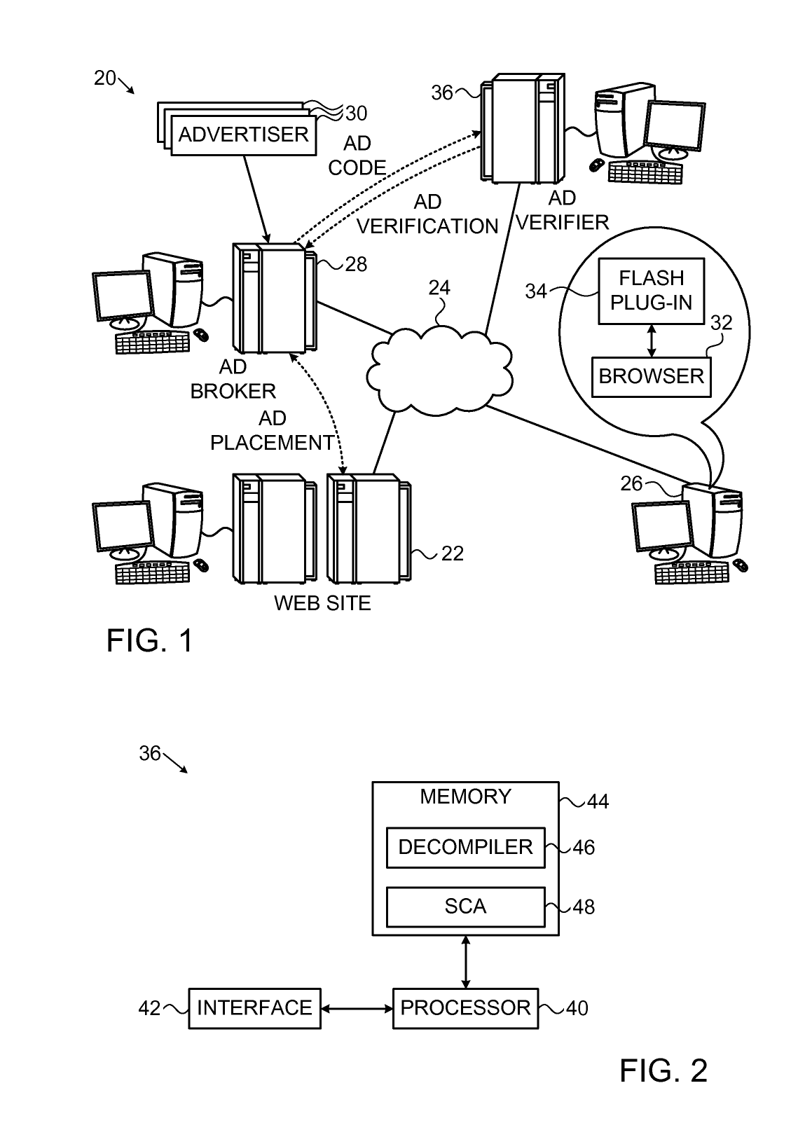

FIG. 1 is block diagram that schematically illustrates a system 20 for content verification and distribution, in accordance with an embodiment of the present invention. System 20 is presented as a non-limiting example of the sort of environment in which the present techniques for detecting malicious active content items may be applied. The principles of the present invention may similarly be implemented to verify active content in other sorts of computing and content distribution environments, as will be apparent to those skilled in the art.

In system 20, a Web site 22 distributes Web pages over a network 24 to client devices 26, such as the personal computer that is shown in the figure. The Web pages contain advertising slots, which are filled by an advertisement broker 28, who provides links to active content items, such as Flash SWF files, that are submitted by advertisers 30. These links are inserted in the appropriate locations in Web pages distributed by Web site 22. Client device 26 runs a browser 32, which displays the Web pages. Upon encountering a link to a Flash advertisement in a given Web page, browser 32 downloads the SWF file and passes it to a Flash plug-in 34, which plays the active content on the client device. Normally, the active content, such as a Flash media item, plays within a certain window (an “ad box”) that is allocated for it in the Web page on which it is to appear.

Advertisement broker 28 typically receives advertisements from many different advertisers 30, and distributes the advertisements for insertion in various Web pages on many different Web sites. Broker 28 and Web site 22 may not be in a position to verify the identity and legitimacy of all the advertisers who submit advertisements for such distribution (and typically pay for this service). Therefore, in this example, broker 28 submits the computer-readable code (such as SWF and HTML5 files) of items of active content that it receives from advertisers 30 to a content verification server 36.

Server 36 applies the techniques of source code analysis that are described herein in order to verify that the code is legitimate and not malicious. Specifically, the server compares features of the source code and its data flow graph to a set of predefined norms in order to verify that the code does not contain attempts to exploit the functionality or vulnerabilities of the client-side player (such as plug-in 34). Upon finding that the code contains no substantive deviations from the norms, server 36 certifies to broker 28 that the active content item has been verified. On the other hand, when a deviation is detected, server reports the deviation to the broker, so that the broker can remove the active content item in question from distribution and take appropriate action against the malicious advertiser.

Although verification server 36 is shown and described here, for the sake of clarity, as a separate, standalone unit, the functions of server 36 may alternatively be integrated with another computer, such as a server operated by broker 28 or Web site 22. The entity requesting that server 36 verify an item of content may be either a human operator, who may submit the request manually via the user interface of the verification software, or another computer or program, which may be configured to submit the request automatically.

FIG. 2 is a block diagram that schematically shows details of content verification server 36, in accordance with an embodiment of the present invention. Server 36 comprises a processor 40, typically embodied in a general-purpose or special-purpose computer, which is programmed in software to carry out the functions that are described herein. The software may be downloaded to processor 40 in electronic form, over a network, for example. Additionally or alternatively, the software may be provided and/or stored on tangible, non-transitory computer-readable media, such as magnetic, optical, or electronic memory. Further additionally or alternatively, at least some of the functions of processor 40 may be carried out by suitable programmable logic circuits.

Server 36 further comprises an interface 42, such as a network communication interface and/or a user interface, through which processor 40 receives items of active content that are to be verified. The processor stores these items in a memory 44 during processing. Memory 44 also holds the software that is run by processor 40 in performing the functions that are described herein. The components of this software may include a decompiler 46, as is known in the art, for converting active content items received in the form of object code, such as SWF files, to source code. Such decompilers are commercially available and are outside the scope of the present disclosure. A source code analysis (SCA) module 48 analyzes the source code in order to detect malicious content, as described below.

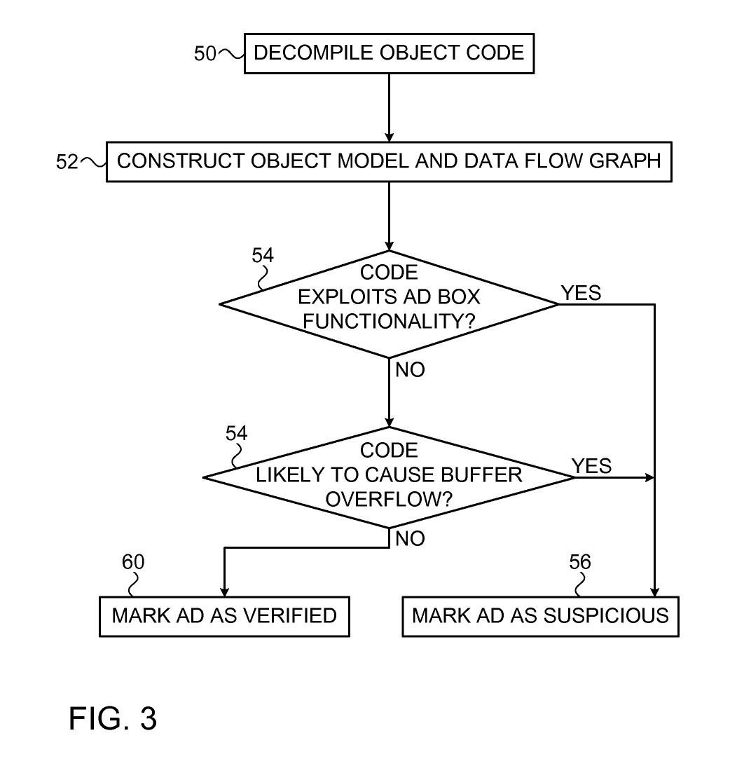

FIG. 3 is a flow chart that schematically illustrates a method for content verification, in accordance with an embodiment of the present invention. This method is described hereinbelow, for the sake of clarity and convenience, with reference specifically to the elements of system 20 and server 36; but the principles of this method may similarly be implemented on substantially any computer having suitable software and resources.

The method of FIG. 3 is initiated when processor 40 receives an item of active content, such as an advertisement sent for verification by broker 28. If the item is in the form of object code, the processor applies decompiler 46 to decompile the object code and thus reconstruct the corresponding source code, at a decompilation step 50. Processor 40 then activates source code analysis module 48 to process the source code.

Module 48 derives an object-based representation, known as a document object model (DOM), of the code, at a code analysis step 52. The source code analysis module uses the DOM to extract flow graphs of the code. These flow graphs typically include a data flow graph (DFG), which represents a flow of information that will be engendered when the code is run. Optionally, the flow graphs may also include a control flow graph (CFG) and a control dependence graph (CDG). Derivation of the DOM and these graphs is described, for example, in U.S. Patent Application Publication 2010/0083240. Processor 40 stores the analysis results in a memory 44, typically in the form of a database to enable convenient access to the data thereafter.

Module 48 analyzes the source code and DFG for signs that the code is attempting to exploit standard, documented functionality of the environment of the client-side player, at an exploitation detection step 54. (In regard to advertising content items, this set of standard functionalities is commonly referred to as the “ad box.”) For this purpose, at step 54, processor 40 checks the source code and DFG of the item of active content for actions that that fall within a set of predefined actions associated with potential exploitation of plug-in 34 on client device 26. The actions may conveniently be defined and searched for using the query language and related techniques that are described in the above-mentioned U.S. Patent Application Publication 2010/0083240. For example, to find attempts to navigate to external sites (one of the categories of exploitation listed below), module 48 may apply DOM and DFG queries to identify any data flow between a string that holds a third-party URL and the “NavigateTo” command.

The actions checked for at step 54 may include some or all of the following examples:
Interaction with, modification of, or manipulation of a hosting page on which the item of active content is to be displayed. In other words, does the active content include code that attempts to alter or otherwise interact with the page provided by Web site 22 in which the item is to be inserted?
Opening the item of active content to play in full-screen mode. In this mode, the Flash window, for example, opens to cover the full computer screen and thus masks the host page.
Timer-based actions, to be performed autonomously by the code of the active content, without intervention of a user of the client device.
Navigating away from a hosting site, on which the item of the active content is to be displayed, to another, different site. In other words, the code of the active content includes a link that will cause browser 32 to open a page at a location outside the domain of Web site 22.
Downloading further active content from another site, different from the hosting site. In the example shown in FIG. 1, the code might prompt browser 32 to download another Flash item from a site other than Web site 22.
Downloading an executable program to client device 26.
Building a string meeting predefined criteria. Such criteria typically indicate that the string is to be built in a manner that masks its actual content. For instance, the code may attempt to build a longer string a few letters at a time by means of string concatenation instructions. Such techniques are rarely used in legitimate software and are usually indicative of an attempt to make the code less readable. String building of this sort may be detected by querying the DFG to find cases in which a string is “DatalnfluencedBy” by more than a given number of string concatenation operators.
An alteration in a functionality of the item of the active content that is scheduled to occur after a predefined time has elapsed. For example, the code of the item may include a command to change functionality after a certain number of days or weeks, in order to foil sandbox-based attempt to detect malicious items.
An alteration in a functionality of the item of the active content that is scheduled to occur on a certain day, such as on a weekend.
Scanning for open ports. This sort of scanning is typically performed in order to search for destinations to which malicious content may be transmitted by client device 26, while under the control of the item in question.

Upon detecting that the source code is designed to perform one or more of the above actions, processor 40 marks the content item as suspicious, at a disqualification step 56. At this point, the process of code verification may stop, and server 36 may simply report its findings to broker 28. Alternatively, processor 40 may continue its analysis of the code for components that are likely to cause a buffer overflow in client device 26, at an overflow detection step 58. The processor proceeds to step 58 in any case when the code has satisfactorily met all the norms tested at step 54. As another alternative, step 58 may be performed before or in parallel with step 54.

Flash players, as well as Web browsers, normally limit the permissions of items of active content that they receive and present so that these items are able to access only a small subset of the overall functionality of the computer. For example, such items are not allowed to access the operating system, hard drive or peripheral devices (such as cameras and microphones). Buffer overflows, however, may enable items of active content to bypass the normal security mechanisms and obtain full access to all resources on client device 26. For this reason, processor 40 checks for elements in the source code that may be indicative of attempts to cause a buffer overflow. Such elements may include, for example, some or all of the following:
Any lines of code containing more than a certain number of characters, for example, more than 2000 characters in a line.
A string or concatenation of strings containing more than a certain number of string characters without interruption. “Interruption” in this context refers generally to specific characters that are commonly used in separating words, such as spaces, underscores, dashes, slashes, and backslashes.
A large number of numerical elements having large values, i.e., the numerical elements have values greater than a certain threshold, and the number of these numerical elements is greater than a certain quota. For example, if the source code includes more than thirty hard-coded integers whose value is greater than 100,000, processor 40 marks the code as suspicious. As another example, the source code may be considered suspicious if it includes more than one hard-coded hexadecimal value greater than 100,000.
A large number of multiplication operators (*) having at least one operand greater than a certain threshold. For example, the source code may be considered suspicious if it contains at least twenty uses of the multiplication operator, each with at least one operand with an integer value greater than 100,000.
A large number of instructions of a certain type that is defined as suspicious, because they may be used to introduce large values into a buffer. Such instructions may include, for example, writelnt, writeByte*, hexto*, UintToDouble, writeUnsignedlnt, and *Endian. If the number of occurrences of any of these instructions is greater than a certain threshold, such as twenty, the code is marked as suspicious.

If processor 40 finds that any of the norms checked at step 58 have been violated, it concludes that the code is likely to cause a buffer overflow, and marks the code as suspicious at step 56. Otherwise, if all the norms of step 58 are satisfied, and the norms of step 54 were satisfied, as well, processor 40 marks the item under test as verified, at a verification step 60. Server 36 may then certify to the requester, such as broker 28, that the content item in question has been verified. Broker 28 and Web site 22 may then distribute links to items, such as advertisements, that have been verified in this manner with a high level of confidence that they do not contain malicious code.

Although the above description of the method of FIG. 3 refers to certain specific criteria that are applied in verification of items of active content, additional and alternative source-code-based criteria may be applied at steps 54 and 58 to detect exploitation of player functionality and attempts to cause buffer overflow. Such criteria will be apparent to those skilled in the art after reading the above description and are considered to be within the scope of the present invention.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for software code analysis, comprising:
receiving in a computer, from a requester, an item of active content to be played on client devices;
automatically analyzing, in the computer, source code of the item in order to generate a data flow graph, representing a flow of information to be engendered in the client devices playing the item;
automatically processing the source code and the data flow graph in the computer in order to detect elements in the flow of the information that deviate from a predefined set of norms; and
reporting deviations from one or more of the norms to the requester.

2. The method according to claim 1, wherein the item of the active content is designed for insertion into a Web page for display by browsers of the client devices.

3. The method according to claim 2, wherein the item of the active content comprises a Flash advertisement.

4. The method according to claim 2, wherein the requester is an advertisement broker, who distributes items for insertion in multiple Web sites, and wherein the method comprises, upon finding no deviations from the norms due to a given item, certifying to the advertisement broker that the given item has been verified.

5. The method according to claim 1, wherein receiving the item comprises receiving object code, and wherein analyzing the source code comprises decompiling the object code in order to generate the source code.

6. The method according to claim 1, wherein analyzing the source code comprises generating an object-based representation of the source code, and extracting the data flow graph from the object-based representation.

7. The method according to claim 1, wherein processing the source code comprises detecting components in the source code that are likely to cause a buffer overflow in the client devices.

8. The method according to claim 7, wherein detecting the components comprises detecting one or more information elements, selected from a group of the information elements consisting of:
a line of code containing more than a first predefined number of characters;
a string or concatenation of strings containing more than a second predefined number of string characters without interruption;
a first number of numerical elements having respective values greater than a first predefined threshold, such that the first number is greater than a first predefined quota;
a second number of multiplication operators having at least one operand greater than a second predefined threshold, such that the second number is greater than a second predefined threshold; and
a third number of instructions of a predefined type, such that the third number is greater than a third predefined threshold.

9. The method according to claim 1, wherein processing the source code comprises detecting actions that the item of the active content is programmed to perform, such that the detected actions fall within a set of predefined actions associated with potential exploitation of the client devices.

10. The method according to claim 9, wherein the predefined actions are selected from a group of actions consisting of:
interaction with, modification of, or manipulation of a hosting page on which the item of the active content is to be displayed;
opening the item of the active content to play in full-screen mode;
timer-based actions, to be performed autonomously without intervention of users of the client devices;
navigating away from a hosting site, on which the item of the active content is to be displayed, to another, different site;
downloading further active content from another site, different from the hosting site, on which the item of the active content is to be displayed;
downloading an executable program to client devices;
building a string meeting predefined criteria;
an alteration in a functionality of the item of the active content that is scheduled to occur after a predefined time has elapsed;
an alteration in a functionality of the item of the active content that is scheduled to occur on a certain day; and
scanning for open ports.

11. Apparatus for software code analysis, comprising:
an interface, configured to receive, from a requester, an item of active content to be played on client devices; and
a processor, which is configured to analyze source code of the item in order to generate a data flow graph, representing a flow of information to be engendered in the client devices playing the item, to process the source code and the data flow graph in the computer in order to detect elements in the flow of the information that deviate from a predefined set of norms, and to report deviations from one or more of the norms to the requester.

12. The apparatus according to claim 11, wherein the item of the active content is designed for insertion into a Web page for display by browsers of the client devices.

13. The apparatus according to claim 12, wherein the item of the active content comprises a Flash advertisement.

14. The apparatus according to claim 12, wherein the requester is an advertisement broker, who distributes items for insertion in multiple Web sites, and wherein the processor is configured, upon finding no deviations from the norms due to a given item, to certify to the advertisement broker that the given item has been verified.

15. The apparatus according to claim 11, wherein the item received via the interface comprises object code, and wherein the processor is configured to decompile the object code in order to generate the source code for analysis.

16. The apparatus according to claim 11, wherein the processor is configured to generate an object-based representation of the source code, and to extract the data flow graph from the object-based representation.

17. The apparatus according to claim 11, wherein the processor is configured to detect components in the source code that are likely to cause a buffer overflow in the client devices.

18. The apparatus according to claim 17, wherein the components detected by the processor comprise one or more information elements, selected from a group of the information elements consisting of:
a line of code containing more than a first predefined number of characters;
a string or concatenation of strings containing more than a second predefined number of string characters without interruption;
a first number of numerical elements having respective values greater than a first predefined threshold, such that the first number is greater than a first predefined quota;
a second number of multiplication operators having at least one operand greater than a second predefined threshold, such that the second number is greater than a second predefined threshold; and
a third number of instructions of a predefined type, such that the third number is greater than a third predefined threshold.

19. The apparatus according to claim 11, wherein the processor is configured to detect in the source code actions that the item of the active content is programmed to perform, such that the detected actions fall within a set of predefined actions associated with potential exploitation of the client devices.

20. The apparatus according to claim 19, wherein the predefined actions are selected from a group of actions consisting of:
interaction with, modification of, or manipulation of a hosting page on which the item of the active content is to be displayed;
opening the item of the active content to play in full-screen mode;
timer-based actions, to be performed autonomously without intervention of users of the client devices;
navigating away from a hosting site, on which the item of the active content is to be displayed, to another, different site;
downloading further active content from another site, different from the hosting site, on which the item of the active content is to be displayed;
downloading an executable program to client devices;
building a string meeting predefined criteria;
an alteration in a functionality of the item of the active content that is scheduled to occur after a predefined time has elapsed;
an alteration in a functionality of the item of the active content that is scheduled to occur on a certain day; and
scanning for open ports.

21. A computer software product, comprising a non-transitory computer-readable medium in which program instructions are stored, which instructions, when read by a computer, cause the computer to receive, from a requester, an item of active content to be played on client devices, to analyze source code of the item in order to generate a data flow graph, representing a flow of information to be engendered in the client devices playing the item, to process the source code and the data flow graph in the computer in order to detect elements in the flow of the information that deviate from a predefined set of norms, and to report deviations from one or more of the norms to the requester.

22. The product according to claim 21, wherein the item of the active content is designed for insertion into a Web page for display by browsers of the client devices.

23. The product according to claim 22, wherein the item of the active content comprises a Flash advertisement.

24. The product according to claim 22, wherein the requester is an advertisement broker, who distributes items for insertion in multiple Web sites, and wherein the instructions cause the computer, upon finding no deviations from the norms due to a given item, to certify to the advertisement broker that the given item has been verified.

25. The product according to claim 21, wherein the item received via the interface comprises object code, and wherein the instructions cause the computer to decompile the object code in order to generate the source code for analysis.

26. The product according to claim 21, wherein the instructions cause the computer to generate an object-based representation of the source code, and to extract the data flow graph from the object-based representation.

27. The product according to claim 21, wherein the instructions cause the computer to detect components in the source code that are likely to cause a buffer overflow in the client devices.

28. The product according to claim 27, wherein the components detected by the computer comprise one or more information elements, selected from a group of the information elements consisting of:
a line of code containing more than a first predefined number of characters;
a string or concatenation of strings containing more than a second predefined number of string characters without interruption;
a first number of numerical elements having respective values greater than a first predefined threshold, such that the first number is greater than a first predefined quota;
a second number of multiplication operators having at least one operand greater than a second predefined threshold, such that the second number is greater than a second predefined threshold; and
a third number of instructions of a predefined type, such that the third number is greater than a third predefined threshold.

29. The product according to claim 21, wherein the instructions cause the computer to detect in the source code actions that the item of the active content is programmed to perform, such that the detected actions fall within a set of predefined actions associated with potential exploitation of the client devices.

30. The product according to claim 29, wherein the predefined actions are selected from a group of actions consisting of:
interaction with, modification of, or manipulation of a hosting page on which the item of the active content is to be displayed;
opening the item of the active content to play in full-screen mode;
timer-based actions, to be performed autonomously without intervention of users of the client devices;
navigating away from a hosting site, on which the item of the active content is to be displayed, to another, different site;
downloading further active content from another site, different from the hosting site, on which the item of the active content is to be displayed;
downloading an executable program to client devices;
building a string meeting predefined criteria;
an alteration in a functionality of the item of the active content that is scheduled to occur after a predefined time has elapsed;
an alteration in a functionality of the item of the active content that is scheduled to occur on a certain day; and
scanning for open ports.
